(19) United States
(12) Patent Application Publication
(10) Pub. No.: US 2007/0143983 A1
(43) Pub. Date: Jun. 28, 2007

(54) Method and apparatus of producing stator

(76) Inventors: Kazuyuki Yamaguchi, Kariya-shi (JP); Yoshio Kato, Inazawa (JP)

Correspondence Address: MORGAN & FINNEGAN, L.L.P., 3 World Financial Center, New York, NY, 10281-2101, US

(21) Appl. No.: 11/639,553

(22) Filed: Dec. 15, 2006

(30) Foreign Application Priority Data
Dec. 16, 2005 (JP) 2005-362939

(51) Int. Cl. H02K 15/00

(52) U.S. Cl. 29/596; 29/598; 29/732

(57) ABSTRACT

Using a jig having on its outer circumference a holding groove group formed by a plurality of slit-shaped holding grooves with pitches of integral multiple pitches of a slot of a stator core, one side of each coil is projected outside the jig, the other side of each coil is inserted into the holding groove group, an auxiliary member having a plurality of blade portions are provided at the end surface of the jig, the jig is inserted into the inner circumference of the stator core from the auxiliary member side, one side of each coil is pushed into a corresponding slot of the stator core, thus the jig is rotated and positioned such that the holding groove can match the corresponding slot of the stator core, and the push out device inserts the other side of each coil into a corresponding slot.

### BACKGROUND OF THE INVENTION

1. Field of the Invention

The present invention relates to a method and an apparatus of producing a stator by inserting one sides of a plurality of prepared coils into the slot of a stator core, inserting the other sides of the plurality of prepared coils into another slot, and spirally combining the coils as viewed from the one side of the stator core.

2. Description of the Related Art

As a method of producing a stator having a prepared coil can be a method of directly winding wire on the inner teeth of a stator core and a method of inserting a prepared coil into a slot of a stator core.

However, in these methods, only a coil obtained by concentrically winding wire on each magnetic pole can be formed. Therefore, a motor using such a stator core causes a nonuniform torque by a phenomenon in which the density of a circular magnetomotive force is nonuniform. Since the nonuniform torque causes the vibration and noise of a motor, there are various propositions to solve the problems.

A motor capable of conspicuously reducing the nonuniform torque can be formed using a stator (hereinafter referred to as a “spiral coil stator”) obtained by inserting one sides of the plurality of prepared coils into the slot of a stator core, inserting the other sides of the plurality of coils into another slot, and spirally combining the coils as viewed from the one side of the stator core.

The obtained stators have short coil ends, their heights are relatively equal, have compact shapes, and are not so nonuniform in torque when they are used in a motor, thereby reducing the vibration and noise of the motor.

However, the above-mentioned spiral coil stator has to be generated by inserting each of both sides of a coil into a slot one by one with another coil overlap each other, and it is hard to mechanically perform the process. Therefore, it is necessary to manually insert a prepared coil into the slot of a stator core, thereby resulting in poor operability in production and high production cost.

On the other hand, as a technique relating to a spiral coil stator, the patent document 1 discloses a method of producing a stator of a motor obtained by sequentially inserting in the direction of the circumference of a stator core a coil piece which is formed in a coil shape and has an inner circumference layer insertion side and an outer circumference layer insertion side into the stator core of the motor in which a plurality of slots having an outer circumference layer and an inner circumference layer, including: a plural wire piece inserting step, as a step of inserting a plural wire coil piece obtained by winding plural turns of a bundle of lead lines of plural fine lines into the slot, of sequentially inserting N plural wire coil piece into the outer circumference layer N pieces distant from the inner circumference layer of the slot in the coil piece insertion order; a single wire piece inserting step, as a step of inserting into the slot after the N-th plural wire coil piece the single wire coil piece obtained by winding plural turns of a single wire line, of inserting the single wire coil piece into the outer circumference layer N pieces distant from the inner circumference layer of the slot; and an interruption inserting step of interruption-inserting the outer circumference layer insertion side of the single wire coil piece after temporarily taking out the inner circumference layer insertion side of the plural wire coil piece from the slot when the outer circumference layer insertion side of the last N single wire coil pieces below the previously inserted inner circumference layer insertion side of the plural wire coil piece.

The patent document 2 discloses a brushless DC motor having a stator coil provided in a slot of a stator by dividing the number of coil lead lines to be prepared at one stage into a plurality of stages.

The patent document 3 discloses a method for producing a multiplayer armature coil for continuously winding a plurality of adjacent inphase coils such that they can be stored in every second slot using 2-layer winding and multiplayer armature coils having the number of slots less than 1 for each phase per pole. After a part of plural layers of continuously wound homopolar coils are stored in the respective slots, at least a part of the coils of other adjacent poles are stored in the slots, and the remaining adjacent continuously wound part or all of coils stored in the slots.

However, in the patent documents 1, 2, and 3 above, the above listed patent documents 1, 2, and 3 do not disclose a method of mechanically performing the operation of inserting a prepared coil into a slot of a stator core, but require manually inserting a coil, and cannot produce a coil at a lower cost on a commercial basis.

[Patent Document 1] Japanese Published Patent Application No. H10-42528

[Patent Document 2] Japanese Published Patent Application No. H10-28346

[Patent Document 3] Japanese Published Patent Application No. S56-41736

### SUMMARY OF THE INVENTION

The present invention aims at providing a method and an apparatus for producing a stator at a low cost on a commercial basis as a spiral coil stator by designing the operation of mechanically and efficiently inserting a prepared coil in a spiral coil stator into a slot of a stator core.

To attain the above-mentioned objective, the method for producing a stator formed by inserting one side of each of a plurality of prepared coils into each slot, and then inserting the other side of each of the plurality of prepared coils into another slot according to the present invention uses a jig having on its outer circumference a holding groove group formed by a plurality of slit-shaped holding grooves with pitches of integral multiple pitches of a slot of a stator core;

projects one side of each of the plurality of prepared coils outside the jig, and arranges each coil along the circumference of the jig with the other side of each of the plurality of prepared coils inserted into the holding groove group;

mounts on the end surface of the jig an auxiliary member having a plurality of blade portions provided corresponding to one or more inner teeth of the stator core, and holds one side of each of the plurality of prepared coils in the corresponding space between the blade portions;

inserts the jig into the inner circumference of the stator core from the auxiliary member side, guides one side of each of the plurality of prepared coils by the auxiliary member, and pushes the one side of each of the plurality of prepared coils into a corresponding slot of the stator core by the edge portion of the jig; and

thus rotates the jig arranged at the inner circumference of the stator core, arranges the jig such that the holding groove can match a corresponding slot of the stator core, pushes the other side of each of the plurality of prepared coils toward the outer circumference by the push out device, and inserts the other side of each of the plurality of prepared coils into the corresponding slot of the stator core.

In the above-mentioned producing method, a plurality of coils can be inserted into a slot with each side overlapping another side in a spiral form, and a spiral stator core can be mechanically and efficiently produced.

In the above-mentioned producing method, it is desired that overlapped coils are inserted by repeating two or more times the operation of inserting one side of each of the plurality of prepared coils and the other side of each of the plurality of prepared coils into the slots by the jig. According to this aspect of the present invention, a sufficient number of coils can be inserted into the slots by repeatedly performing the operation two or more times although the restrictions on the inner diameter of a stator core, etc. do not allow a sufficient width or length of the holding groove of a jig, and a sufficient number of coils cannot be inserted into the slots in one inserting operation. In addition, since spirally overlapping coils can be inserted as a plurality of layers, coil ends can be more equally shortened.

Furthermore, it is desired that a push out jig obtained by arranging a tabular pusher which narrows toward its tip on the holding groove is used as the push out device, the tip of the pusher of the push out jig is inserted into each of the corresponding holding grooves, the other side of the coil inserted into the holding groove is pushed out toward the outer circumference, and inserted into the corresponding slot of the stator core. According to this aspect of the present invention, the sides of a plurality of coils held in the holding grooves of the jig can be simultaneously inserted into the corresponding slots by inserting and pushing the tip of the pusher of the push out jig into each of the corresponding holding grooves.

It is also desired that a device for generating repulsion by an eddy-current by passing an electric current through a coil is used as the push out device, and the coil is pushed out by the repulsion toward the outer circumference from the holding groove of the jig, thereby inserting the coil into the corresponding slot of the stator core. According to this aspect of the present invention, the side of a coil can be inserted into a corresponding slot by a simple operation of passing a current through the coil.

Furthermore, it is desired that a device for generating a Lorentz force by passing a current through a coil by generating a magnetic field traversing the holding groove of the jig is used as the push out device, and the coil is pushed out toward the outer circumference from the holding groove of the jig by the Lorentz force, and inserted into the corresponding slot of the stator core. According to this aspect of the present invention, the side of a coil can be inserted into a corresponding slot by a simple operation of passing a current through the coil.

It is also desired to pass a direct current or an alternating current of a low frequency of 20 Hz or lower through the coil inserted into the slot of the stator core, and press the coil toward the stator core. According to the aspect of the present invention, the inserted coil can be correctly held in the slot.

Furthermore, it is also desired to rotate a jig while pushing one side of each of the plurality of prepared coils toward the stator core and the other side of each of the plurality of prepared coils toward the jig with a direct current or an alternating current at a low frequency of 20 Hz or lower flowing through the coil when the jig is rotated the slot of the stator core with one side of each of the plurality of prepared coils inserted into the corresponding slot of the stator core and the other side of each of the plurality of prepared coils inserted into the holding groove of the jig and held therein. According to the aspect of the present invention, since the jig can be rotated with one side of each of the plurality of prepared coils pressed toward the stator core, and the other side of each of the plurality of prepared coils toward the jig, the insulating coating wire can be protected against damage between the jig and the stator core.

Additionally, it is also desired to press using a pair of rotation auxiliary jigs each coil end projecting from the stator core and both end surfaces of the jig toward the jig in the axis direction when the jig is rotated for the slot of the stator core with one side of each of the plurality of prepared coils inserted into the corresponding slot of the stator core and the other side of each of the plurality of prepared coils inserted into the holding groove of the jig and held therein. According to the aspect of the present invention, the by pressing the coil end toward the jig in the axis direction by the rotation auxiliary jigs, the loop of the coil is enlarged, thereby reducing the force applied to the jig by the enlargement of the coil against the rigidity of the coil when the jig rotates, and preventing the deformation of the jig.

Furthermore, it is desired to insert one by one the side of each coil into each slot in one operation by inserting one side of each of the plurality of prepared coils into every second slot of a stator core and then inserting the other side of each of the plurality of prepared coils into the remaining slot. According to the aspect of the present invention, since the half number of holding grooves as the slots of the stator core can be formed in the jig, the width and the length of the holding groove can be sufficiently set, and the total sectional area of the coil wire that can be held on the holding groove, that is, the total sectional area of the coil wire that can be inserted into the slots of the stator core in one operation, can be increased relatively largely.

Furthermore, when the total sectional area of the coil inserted into the slots of the stator core is Scu, the inner radius of the stator core is Rin, the number of slot is Slot, and the width of the holding groove is d, it is desired that the present invention is applied to the stator core satisfying the equation of Scu>Rin·d−Slot·d²/4π.

According to the aspect of the present invention, the coil wire held in the holding groove of the jig can be easily and correctly inserted into the slot of the stator core.

On the other hand, the apparatus for producing a stator formed by inserting one side of each of the plurality of prepared coils into a slot of a stator core, and then inserting the other side of each of the plurality of prepared coils into another slot according to the present invention includes:

a jig having on its outer circumference a holding groove group that can be inserted into the inner circumference of the stator core, and formed by a plurality of slit-shaped holding grooves with pitches of integral multiple pitches of the slot of the stator core;

an auxiliary member having a plurality of blade portions provided corresponding to one or more inner teeth of the stator core; and

a push out device for inserting the coil inserted into the holding groove group of the jig into the corresponding slot.

According to the above-mentioned producing apparatus, one side of each of the plurality of coils is projected outside the jig, and the other side of each of the plurality of prepared coils is inserted into the holding groove group, each coil is arranged along the circumference of the jig, an auxiliary member having a plurality of blade portions provided corresponding to one or more inner teeth of the stator core is mounted on the end surface of the jig, one side of each of the plurality of prepared coils is held in the space between the corresponding blade portions, and the jig is inserted from the auxiliary member side into the inner circumference of the stator core, and guiding one side of each of the plurality of prepared coils by the auxiliary member, and pushing the side into the corresponding slot of the stator core by the edge portion of the jig. Thus, by rotating the jig arranged on the circumference of the stator core, positioning the jig such that the holding groove can match the corresponding slot of the stator core, pushing the other side of each of the plurality of prepared coils by the push out device toward the outer circumference, inserting the side into a corresponding slot of the stator core, thereby capable of inserting each one side of a plurality of coils into the slot in such a way that spiral overlapping can be performed, and mechanically and efficiently producing a spiral stator.

According to the present invention, a plurality of coils can be inserted into the slot with each side overlapping another side in a spiral form, and a spiral stator can be mechanically and efficiently produced.

### BRIEF DESCRIPTION OF THE DRAWINGS

FIG. 1 is a perspective view showing a mode for embodying the apparatus for producing a stator according to the present invention;

FIG. 2 is a perspective view showing the relationship between the jig, the auxiliary member, and the stator core in the producing apparatus;

FIG. 3 shows the state of holding a coil in the jig and providing an auxiliary member for the jig in a mode for embodying the method for producing a stator according to the present invention;

FIG. 4 is a perspective view of the state of inserting the jig from the auxiliary member side into the inner circumference of the stator core according to the mode for embodying the present invention;

FIG. 5 is a partially enlarged sectional view showing the state of inserting the jig into the inner circumference of the stator core according to the mode for embodying the present invention;

FIG. 6 is a partially enlarged sectional view showing the state of inserting a side of a coil through the space between the blade portions of the auxiliary member into the slot of the stator core according to the mode for embodying the present invention;

FIG. 7 is a perspective view from the bottom showing the state of inserting the jig into the inner circumference of the stator core according to the mode for embodying the present invention;

FIG. 8 is a perspective view showing the state of removing the auxiliary member according to the mode for embodying the present invention;

FIG. 9 is a plan view showing the state of inserting the jig into the inner circumference of the stator core according to the mode for embodying the present invention;

FIG. 10 is a plan view showing the state of rotating the jig for the stator core by predetermined degrees according to the mode for embodying the present invention;

FIG. 11 is a perspective view showing the state of pushing out the other side of each of the plurality of prepared coils held in the holding groove of the jig by the pressure jig according to the mode for embodying the present invention;

FIG. 12 is a plan view showing the state of inserting the other side of each of the plurality of prepared coils held in the holding groove of the jig into the corresponding slot of the stator core according to the mode for embodying the present invention;

FIG. 13 is a plan view showing the shape of the coil end of the stator obtained according to the mode for embodying the present invention;

FIG. 14 is a side view of the stator;

FIG. 15 is a perspective view of the stator;

FIG. 16 is a schematic chart as a plan view showing another mode for embodying the method for producing the stator according to the present invention;

FIG. 17 is an explanatory view showing as a section the coil charged in the slot of the stator obtained according to the mode for embodying the present invention;

FIG. 18 is a plan view showing the shape of the coil end of the stator obtained according to the mode for embodying the present invention;

FIG. 19 is an explanatory view showing another embodiment of the push out device in the stator producing method according to the present invention;

FIG. 20 is an explanatory view showing a further embodiment of the push out device in the stator producing method according to the present invention;

FIG. 21 is an explanatory view showing a further embodiment of the push out device in the stator producing method according to the present invention;

FIG. 22 is an explanatory view showing a further embodiment of the push out device in the stator producing method according to the present invention;

FIG. 23 is an explanatory view showing a further embodiment of the push out device in the stator producing method according to the present invention;

FIG. 24 is an explanatory view showing the state of inserting the jig into the inner circumference of the stator core, inserting one side of each of the plurality of prepared coils into the slot of the stator core, and holding the other side of each of the plurality of prepared coils in the holding groove of the jig according to another mode for embodying the stator producing method according to the present invention;

FIG. 25 is an explanatory view showing the state of rotating the jig for the stator core by predetermined degrees in the mode for embodying the present invention;

FIG. 26 is an explanatory view showing the state of inserting the other side of each of the plurality of prepared coils held in the holding groove of the jig into the slot of the stator core according to the mode for embodying the present invention;

FIG. 27 is an explanatory view used in considering the relationship between the holding groove of the jig and the slot of a stator core;

FIG. 28 is an explanatory view showing the rotation auxiliary jig used in a further mode for embodying the method for producing the stator according to the present invention; and

FIGS. 29A and 29B are explanatory views showing the states before and after pressing the coil end according to the mode for embodying the present invention.

### DESCRIPTION OF THE PREFERRED EMBODIMENTS

The mode for embodying the present invention is explained below by referring to the attached drawings

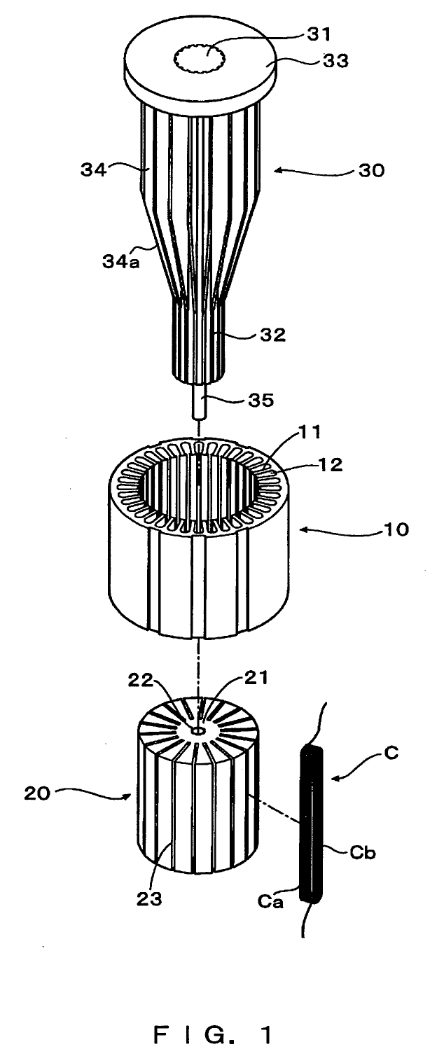

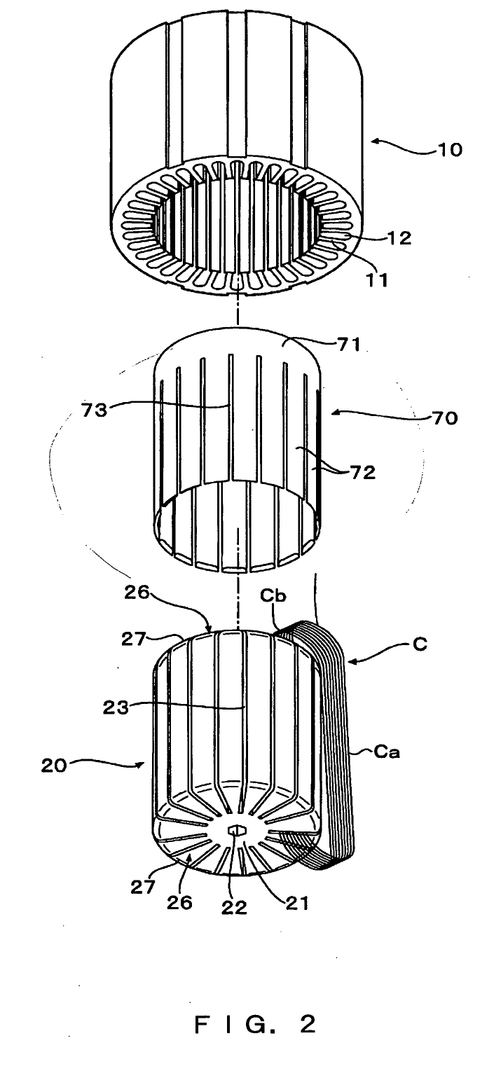

FIGS. 1 and 2 show a mode for embodying the apparatus for producing a stator according to the present invention.

In FIGS. 1 and 2, a stator core 10 has an inner tooth 11 at the inner circumference, and a slot 12 is formed between the inner teeth 11.

The producing apparatus has a substantially cylindrical jig 20 inserted inside the inner circumference of the stator core 10. The jig 20 has a central axis portion 21, a hole 22 provided at the center of the top surface of the axis portion 21, and a plurality of holding grooves 23 radially formed from the outer circumference of the axis portion 21 from the outer circumference of the axis portion 21 toward the outer circumference of the cylindrical jig.

The holding groove 23 is formed with pitches of integral multiple pitches of the slot 12 of the stator core 10. In this mode for embodying the present invention, the holding groove 23 is formed with double the pitch of the slot 12 of the stator core 10, and the holding grooves 23 a half in number of the slots 12 are formed. In this mode for embodying the present invention, the holding groove 23 is radially formed from the outer circumference of the axis portion 21 of the jig 20 along the radius of the jig, but the holding groove 23 can be, for example, spirally curved, etc., or tilted relative to the radial array. In this case, the number of coil sides stored in the holding grooves can be increased.

The coil C is arranged along the circumference of the jig 20 with one side Ca projected outside the jig 20, and the other side Cb inserted into the holding groove 23 of the jig 20. Especially, as shown in FIG. 2, the jig 20 has an edge portion 27 formed as having an R-shaped surface between the circumference surface and an end surface 26. According to the present invention, the end surface refers to the surface of the end portion in the insertion direction of the jig 20 in the insertion direction when the jig 20 is inserted at the inner circumference of the stator core 10, and the edge portion refers to the angular circumference positioned between the circumference surface and the end surface as described above.

On one end surface of the jig 20, an auxiliary member 70 is arranged. The auxiliary member 70 is cylindrical on the whole, and has a base portion 71 and a plurality of tabular blade portions 72 arranged from the base portion 71 along the circumference at predetermined intervals extending in the axis direction. Between the blade portions 72, a slit-shaped space 73 is formed. The auxiliary member 70 is provided such that the separate end portion of the blade portion 72 touches one end surface of the jig 20. At this time, one side Ca of the coil C held by the jig 20 in the aspect described above is inserted into each corresponding space 73 of the blade portion 72, and one side Ca is set in the state of projecting toward the outer circumference.

The circumference of the blade portion 72 of the auxiliary member 70 touches the inner circumference of the inner tooth 11 of the stator core 10, and the space 73 is positioned corresponding to the slot 12 of the stator core 10 in the rotation and positioning processes, thereby inserting the auxiliary member 70 into the stator core 10.

In FIG. 1, the producing apparatus has a pressure jig 30 as a push out device for pushing the other side Cb of the coil C inserted and held in the holding groove 23 of the jig 20 into the corresponding slot 12 of the stator core 10. The pressure jig 30 has a central axis 31. As the outer circumference of the axis 31, a guide groove 32 along the axis is formed at predetermined intervals along the circumference, the diameter of a lower end 35 of the axis 31 is reduced and inserted into the hole 22 of the jig 20.

A circular body 33 is attached to the outer circumference of the axis 31 such that it can be slid vertically. The circular body 33 has inner teeth to be engaged with the guide groove 32 of the axis 31 at the inner circumference of the circular body 33. At the lower surface of the circular body 33, a plurality of tabular pushers 34 are attached, and each pusher 34 is engaged with the corresponding guide groove 32 of the axis 31, and radially attached to the axis 31. The pusher 34 has a taper portion 34a tapering toward the lower portion of the axis 31. The guide groove 32 of the axis 31 and the pusher 34 are, in this mode for embodying the present invention, formed by the number and at the pitch such that they can be inserted every second slot 12 of the stator core 10.

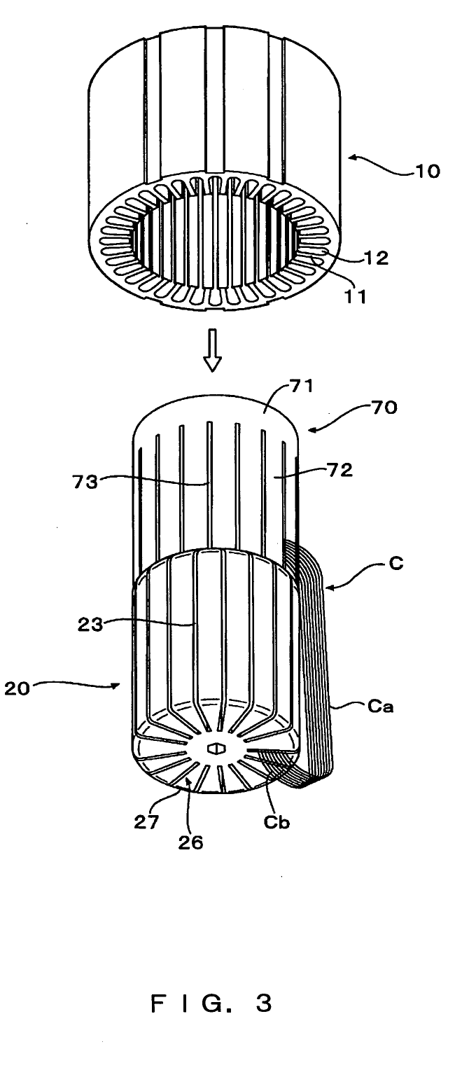

FIGS. 3 through 15 show a mode for embodying the stator producing method according to the present invention using the above-mentioned producing apparatus.

As described above, the other side Cb of the coil C is inserted into the holding groove 23, and a plurality of coils C are arranged along the circumference of the jig 20. In this state, the coil C is interposed between the spaces 73 of the blade portion 72 of the auxiliary member 70, and the auxiliary member 70 is mounted on the end surface of the jig 20. The coil C is held with one side Ca projected toward outside the jig 20 and the auxiliary member 70.

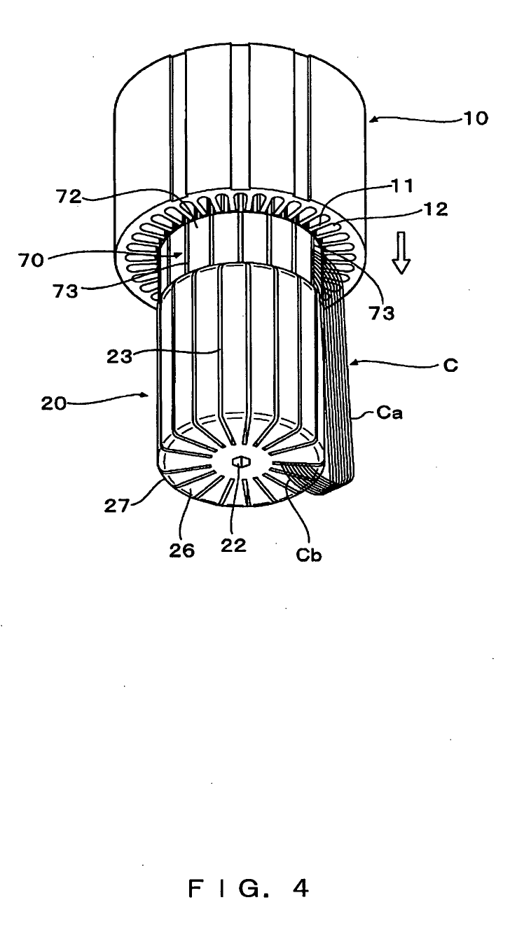

In this state, the jig 20 is inserted from the auxiliary member 70 side into the inner circumference of the stator core 10. At this time, as shown in FIG. 4, the blade portion 72 touches the inner circumference of the inner tooth 11 of the stator core 10, and the space 73 of the blade portion 72 corresponds to the slot 12 of the stator core 10 as a result of the rotating and positioning processes. In addition, the space 73 of the blade portion 72 is positioned between the holding grooves 23 of the jig 20, and the one side Ca of the coil C projected outside the space 73 is carried on the edge portion 27 of the jig 20.

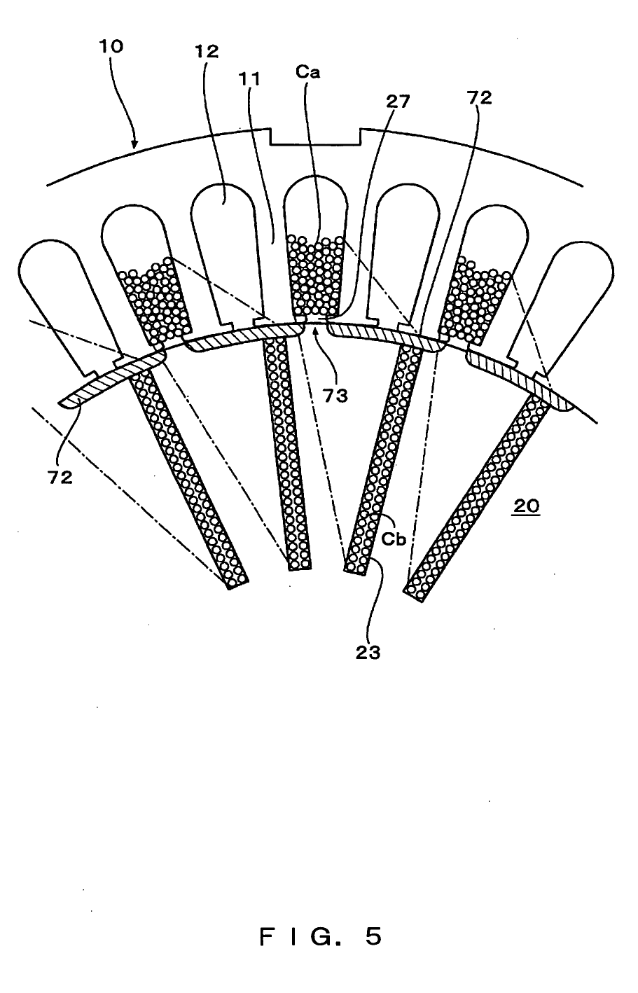

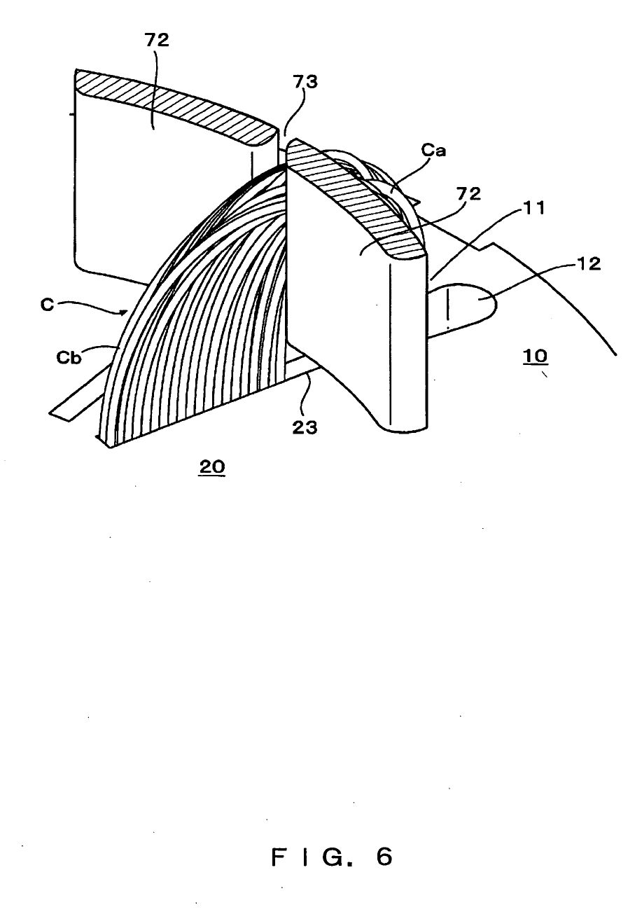

Thus, when the jig 20 is inserted from the auxiliary member 70 side into the inner circumference of the stator core 10, the edge portion 27 of the jig 20 pushes the one side Ca of the coil C into the slot 12 of the stator core 10 using the space 73 between the blade portions 72 as a guide as shown in FIGS. 5 and 6. At this time, the both sides of the blade portion 72 form semielliptic curves such that the space 73 expands toward the inner circumference, and the edge portion 27 of the jig 20 is also curved. Therefore, the coil C is smoothly inserted into the slot 12 without any damage. When the blade portion 72 touches the inner circumference of the inner tooth 11 of the stator core 10, the holding groove 23 is set such that the holding groove 23 cannot match the slot 12, thereby preventing the other side Cb of the coil C in the holding groove 23 from being inserted into the slot 12 when the jig 20 is inserted into the inner circumference of the stator core 10.

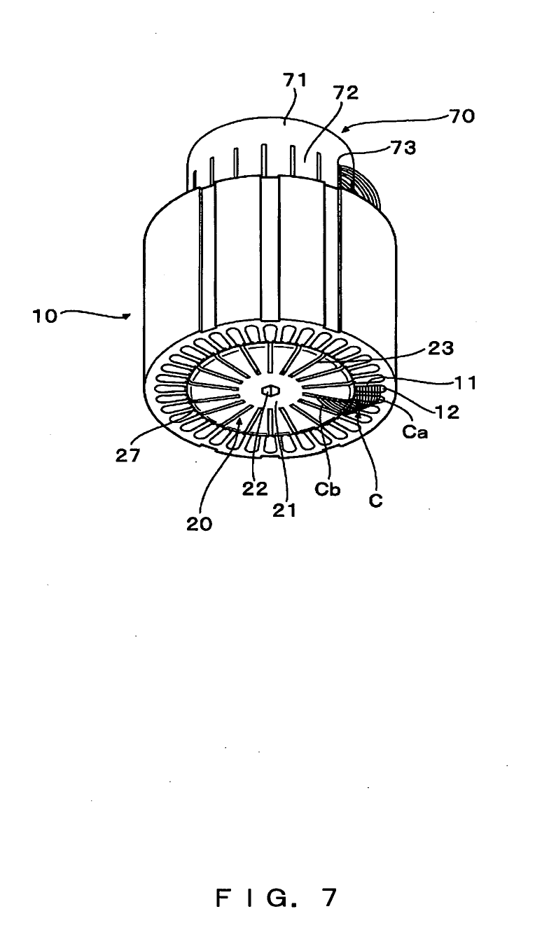

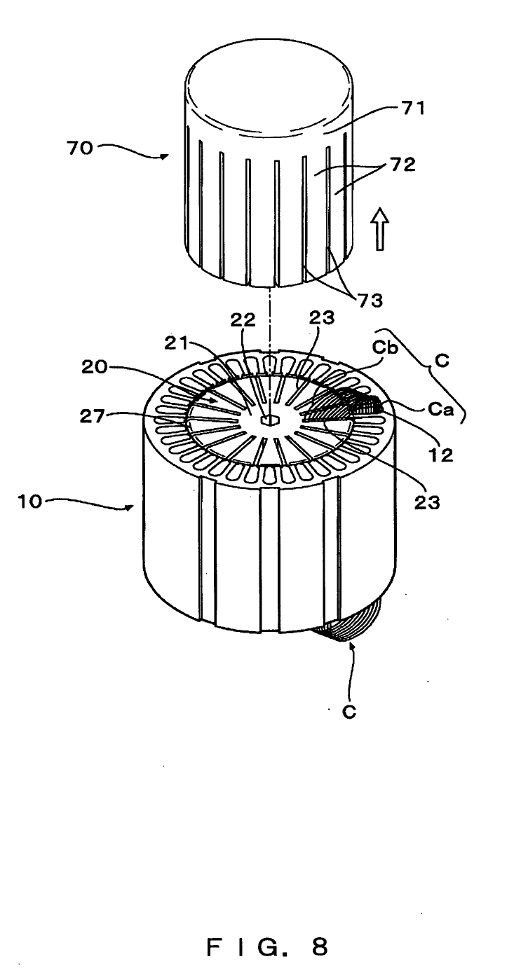

FIG. 7 shows the state of completely inserting the jig 20 into the inner circumference of the stator core 10. In each perspective view showing the mode for embodying the present invention, only one coil is shown for convenience, but each coil C is practically held by each of the holding grooves 23 of the jig 20. In this state, one side Ca of the coil C is inserted into the corresponding slot 12, and the other side Cb is inserted into the corresponding holding groove 23. In this state, as shown in FIG. 8, the auxiliary member 70 is separated from the end surface of the jig 20, and each coil C is extracted from the space 73.

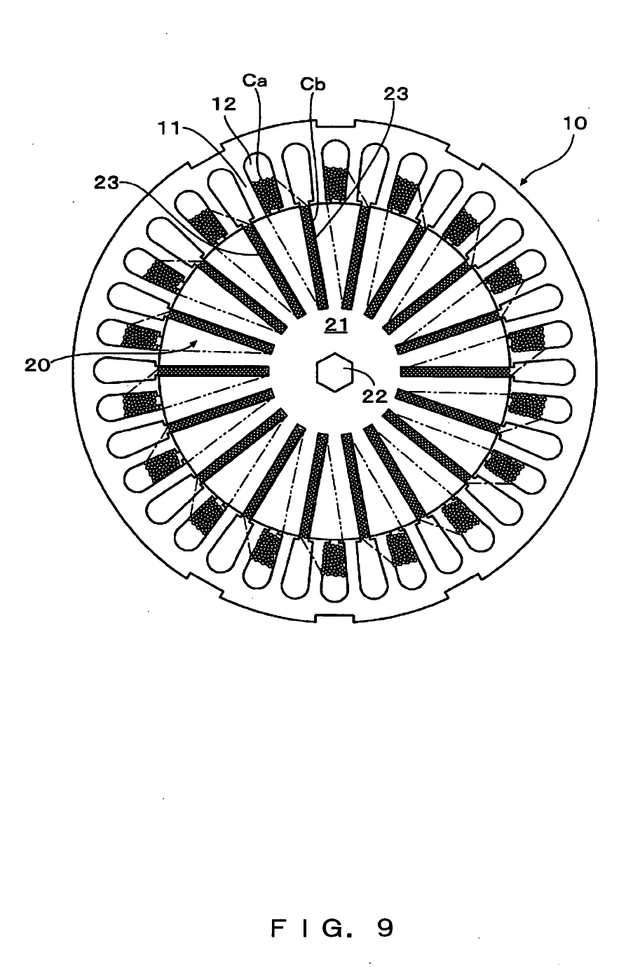

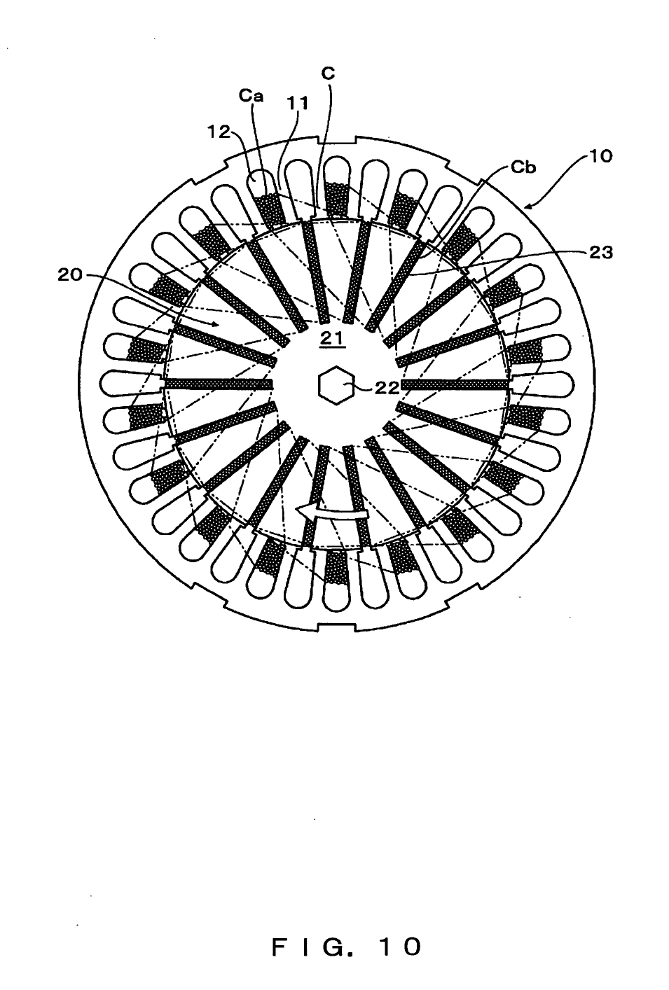

FIG. 9 is an explanatory view showing this state in a two-dimensional array. That is, one side Ca of the coil C is inserted into the corresponding slot 12 of the stator core 10, and other side Cb is held by the holding groove 23 adjacent to the slot 12 into which the one side Ca of the jig 20 is inserted. In this state, as shown in FIG. 10, the jig 20 is rotated by predetermined degrees in a predetermined direction and positioned such that the other side Cb of the coil C held by the holding groove 23 can match a predetermined slot 12. In the present mode for embodying the present invention, the rotation is performed such that the holding groove 23 holding the other side Cb can match the fifth slot 12 ahead of the slot 12 holding one side Ca.

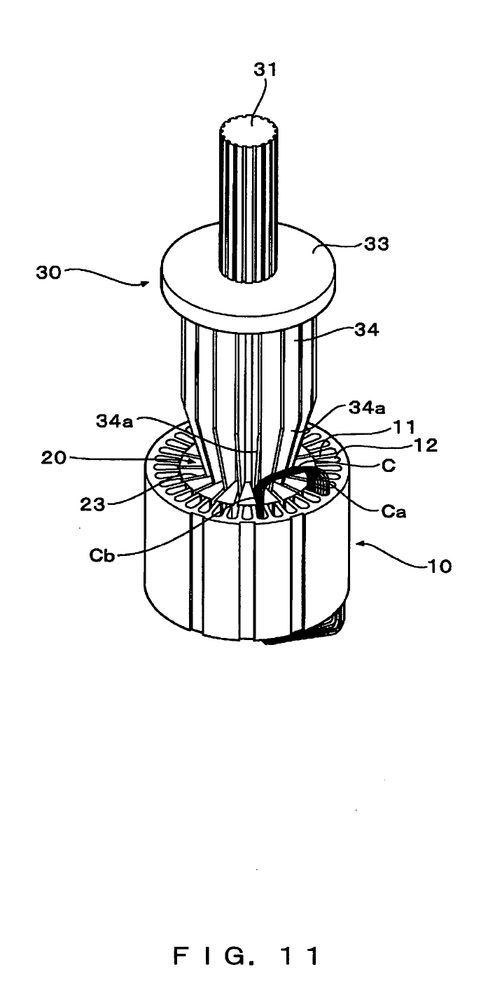

Next, as shown in FIG. 11, the pressure jig 30 pushes out the other side Cb of the coil C held by the holding groove 23 of the jig 20 toward the outer circumference, and inserts it into the corresponding slot 12 of the stator core 10. That is, the pressure jig 30 shown in FIG. 2 is provided above the jig 20, and the pusher 34 matches the holding groove 23, thereby rotating and positioning the jig 20.

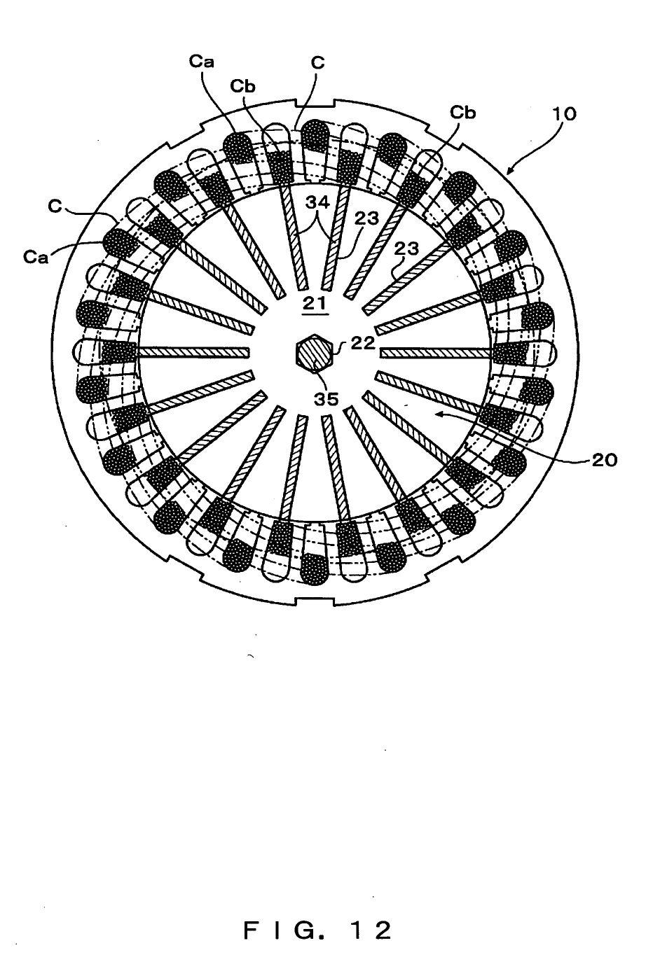

The circular body 33 is slid down on the axis 31, and the pusher 34 is inserted into the holding groove 23 from the lower end. Then, the other side Cb of the coil C inserted into the holding groove 23 is pushed by the taper portion 34a of the pusher 34 toward the outer circumference and inserted into the slot 12 of the stator core 10. FIG. 12 shows the state in which the other side Cb of the coil C is completely inserted into the slot 12.

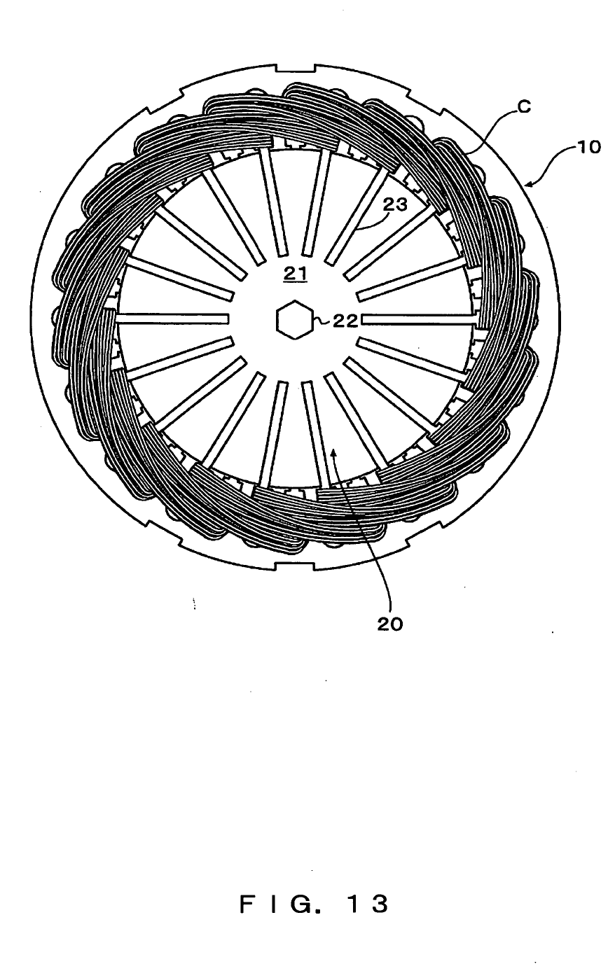

Thus, the one side Ca of the coil C is inserted into the slot 12, and the other side Cb of the coil C is inserted into the fifth slot 12 ahead from the one side Ca of the coil C. Since the inserting operation is performed simultaneously on a plurality of coils C, the coils C are inserted such that the coil ends look spiral from the end surface of the stator core 10 as shown in FIG. 13.

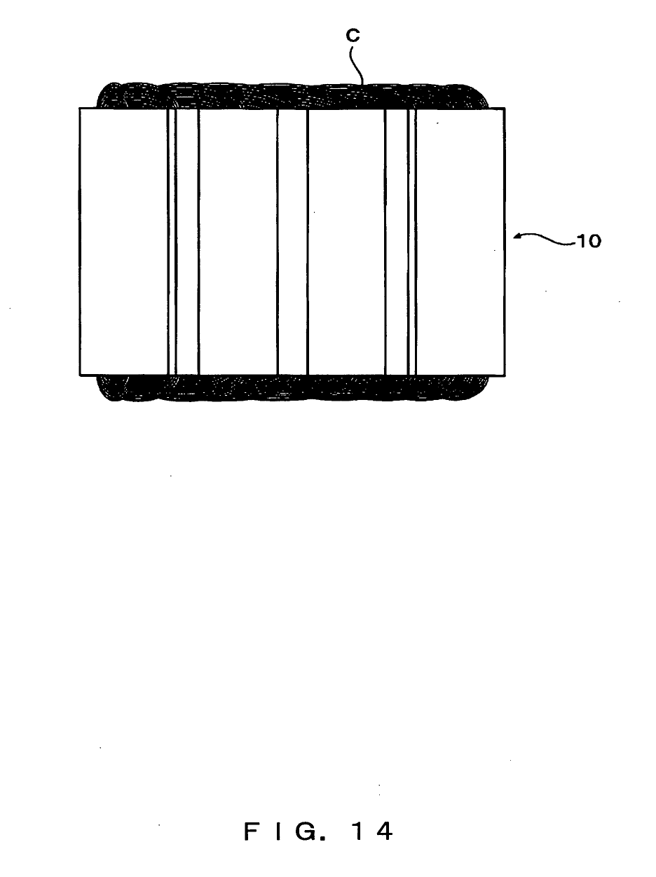

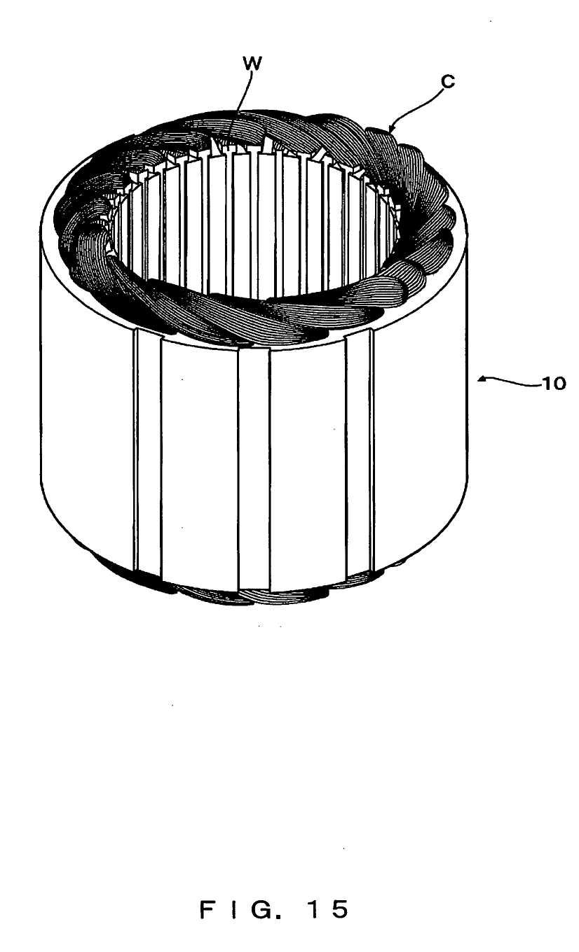

FIG. 14 is a side view of the produced stator core. FIG. 15 is a perspective view of the stator core. Thus, the coil end as a projection portion of the coil C is relatively low in height and equal over the circumference.

After the one side Ca of the coil C held by the jig 20 is inserted, the jig 20 is rotated and positioned, and the other side Cb is inserted. Therefore, the coil C is appropriately expanded in the direction of the circumference and inserted. Furthermore, unlike the method of inserting the coil from one end of a normal stator core to the other end, the coil C is inserted from the inner circumference toward the inner tooth 11 of the stator core 10. Therefore, the coil C is appropriately expanded in the direction of the circumference and inserted. As a result, the coil end can be reduced.

Since the stator core is arranged in the direction of the circumference with each coil C partially overlapping each other, the nonuniform cogging torque can be considerably reduced in a motor, thereby conspicuously decreasing the vibration and noise. Furthermore since the coil end can be compact and can evenly project, a compact stator core 10 and a compact motor using the stator core 10 can be realized.

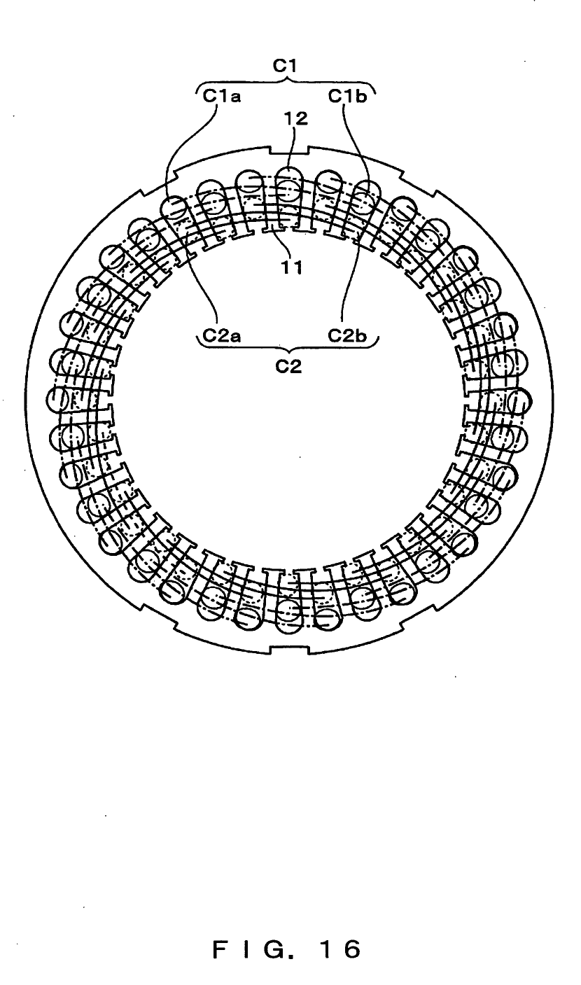

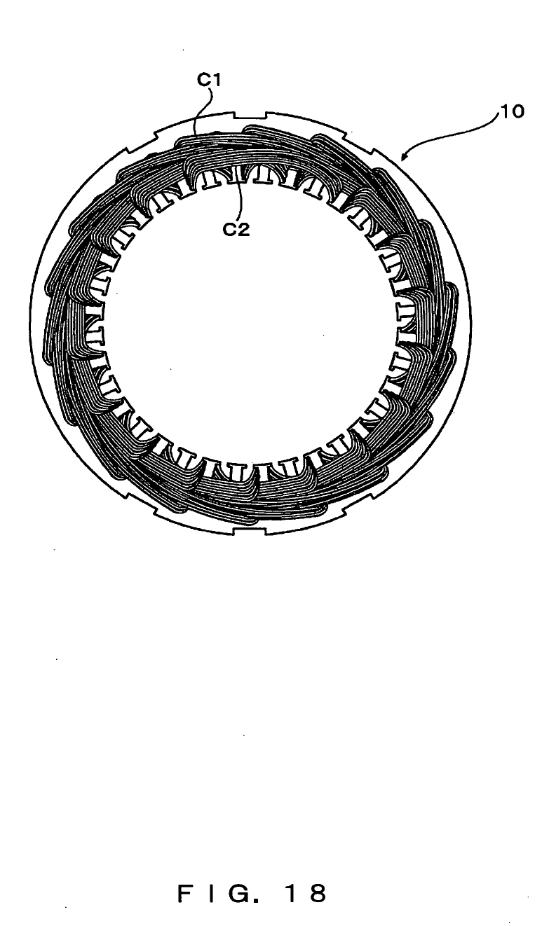

FIGS. 16 through 18 show another mode for embodying the stator producing method according to the present invention. In this producing method, the producing step according to the mode for embodying the present invention is repeated twice. That is, in each slot 12 of the stator core 10, the one side C1a or the other side C1b of the coil C1 inserted in the first step is inserted into the outer circumference of the slot 12, and the one side C2a or the other side C2b of the coil C2 inserted in the second step is inserted into the inner circumference of the slot 12. That is, the one sides C1a and C2a of the coils C1 and C2 are inserted as overlapping each other inside and outside into every second slot 12 of the stator core 10, and the other sides C1b and C2b of the coils C1 and C2 are inserted as overlapping each other inside and outside into the slot 12 positioned between them.

Thus, in the formed stator core, as shown in FIGS. 16 through 18, the coil end of the coil C1 inserted in the first step is spirally formed at the outer circumference, and the coil end of the coil C2 inserted in the second step is also spirally formed at the inner side, thereby forming a double spiral structure.

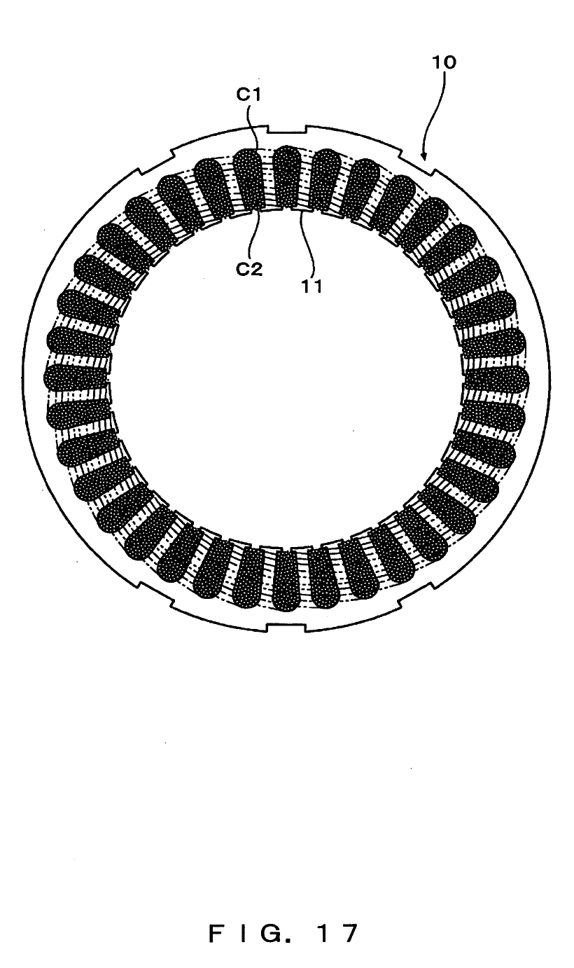

In this method, although a sufficient amount of coils C cannot be inserted and held in inserting one slot 12 into the holding groove 23 of the jig 20, a sufficient amount of coils C can be inserted as shown in FIG. 17 by repeating twice the inserting operation. The frequency of the inserting operation is not limited to twice, but can also be repeated three times or more.

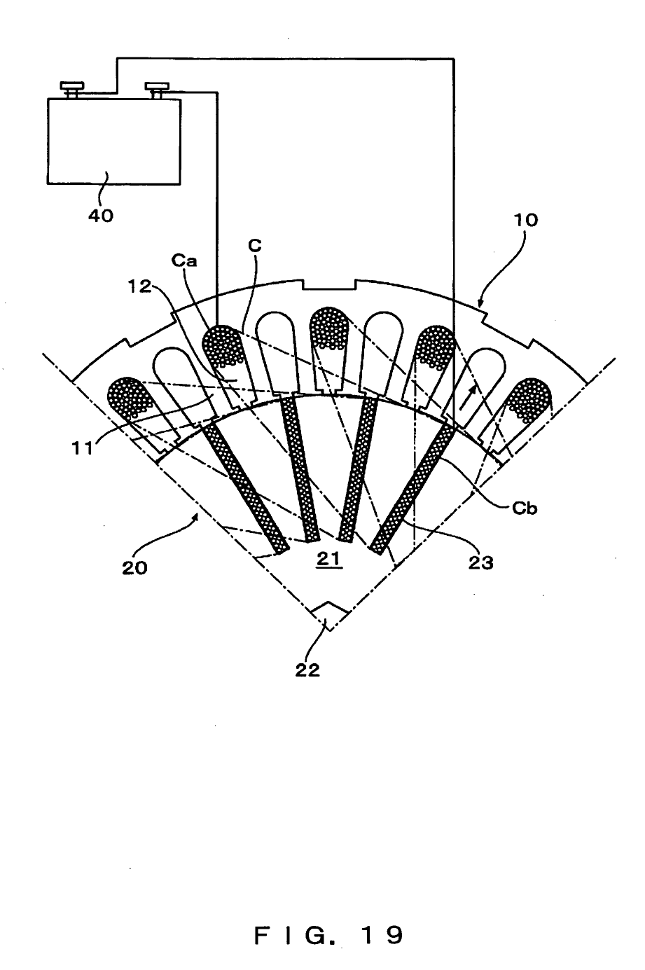

FIG. 19 shows another mode for embodying the present invention by changing the push out device of the coil C in the above-mentioned producing method.

In this mode for embodying the present invention, the power supply 40 is connected to both end portions of the coil C with the jig 20 formed by a nonmagnetic substance such as, for example, aluminum inserted into the inner circumference of the stator core 10, one side Ca of the coil C inserted into the corresponding slot 12 of the stator core 10, and the other side Cb inserted into the corresponding holding groove 23 of the jig 20, thereby passing an electric current through the coil C. In this case, the jig 20 is rotated and positioned such that the holding groove 23 of the jig 20 holding the other side Cb of the coil C can match the fifth slot 12 ahead for the slot 12 into which the side Ca is inserted. In this state, if a sudden transient current is passed through the coil C, the repulsion by the eddy-current works and causes the effect of the force to push out the coil C toward the outer circumference. As a result, the other side Cb of the coil C can be inserted into the corresponding slot 12. Thus, since the coil can be pushed out toward the outer circumference only by passing the current, the structure of the producing apparatus can be simplified, and the coil can be quickly inserted.

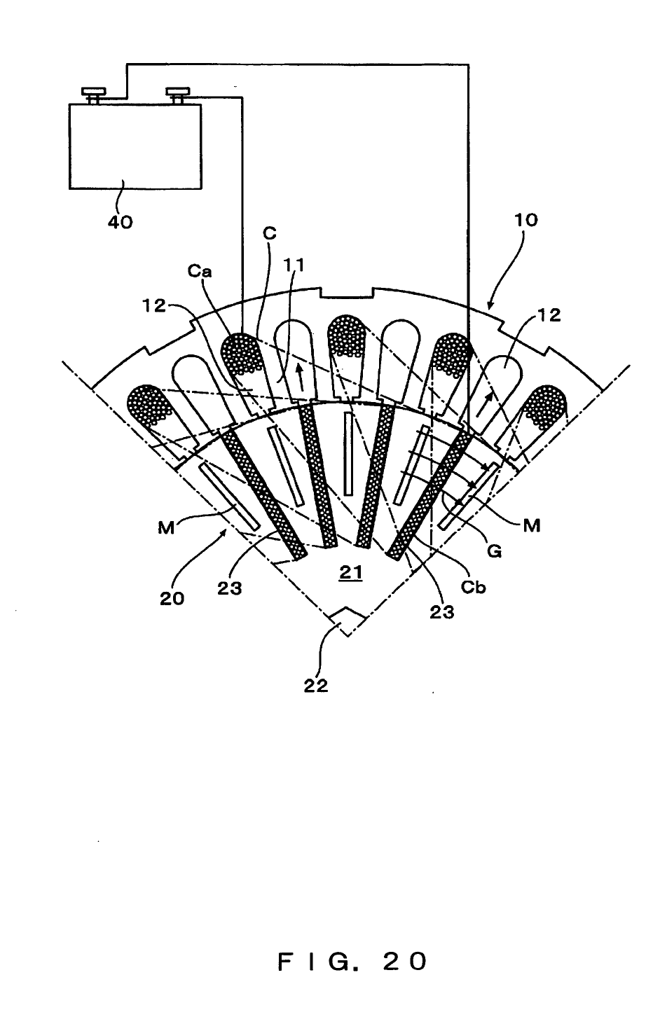

FIG. 20 shows another mode for embodying the present invention with a push out device changed in the producing method according to the present invention.

In this mode for embodying the present invention, a permanent magnet M is embedded in the radial partition positioned between the holding grooves 23 of the jig 20, and the permanent magnet M forms a circular magnetic field G across the holding groove 23. In this state, when the current passes through the coil C from a power supply 40, a Lorentz force works, a push out force to push out the other side Cb of the coil C held by the holding groove 23 is generated toward the outer circumference. As a result, the other side Cb can be inserted into a corresponding slot 12.

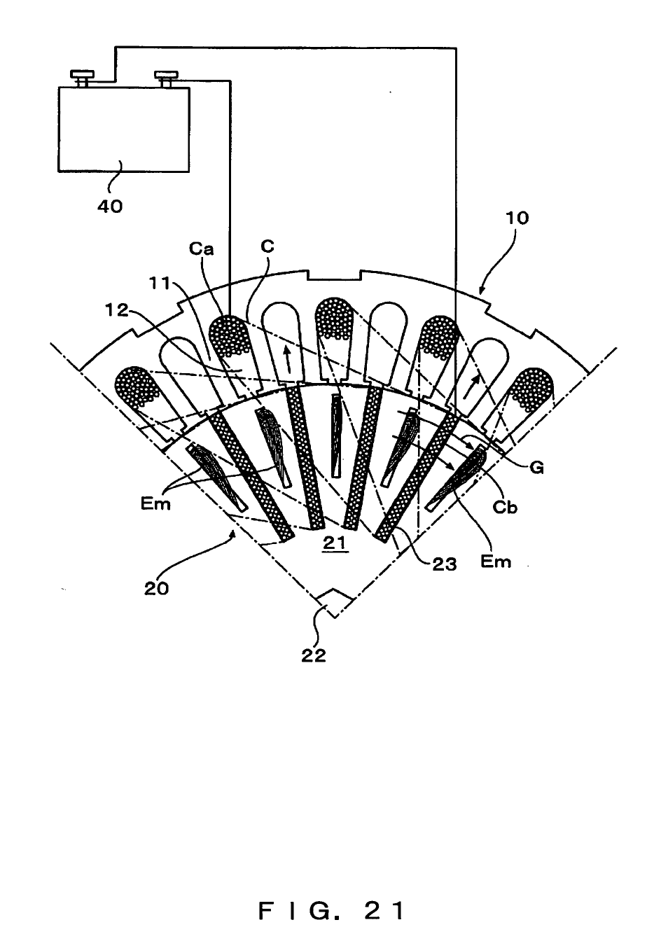

FIG. 21 shows another mode for embodying the present invention with the push out device changed in the producing method according to the present invention.

This mode is basically the same as the mode shown in FIG. 20, but is only different in an electromagnetic Em replaces the permanent magnetic M. That is, an insertion groove toward the axis is formed in the partition formed between the holding grooves 23, the electromagnet Em is inserted into the insertion groove, and an electric current is passed through the electromagnet Em from the power supply circuit not shown in the attached drawings, thereby forming a circular magnetic field G across the holding groove 23. Therefore, by passing a current through the coil C in this state, the push out force is exerted toward the outer circumference on the other side Cb as in the above-mentioned mode, and the other side Cb can be inserted into the corresponding slot 12.

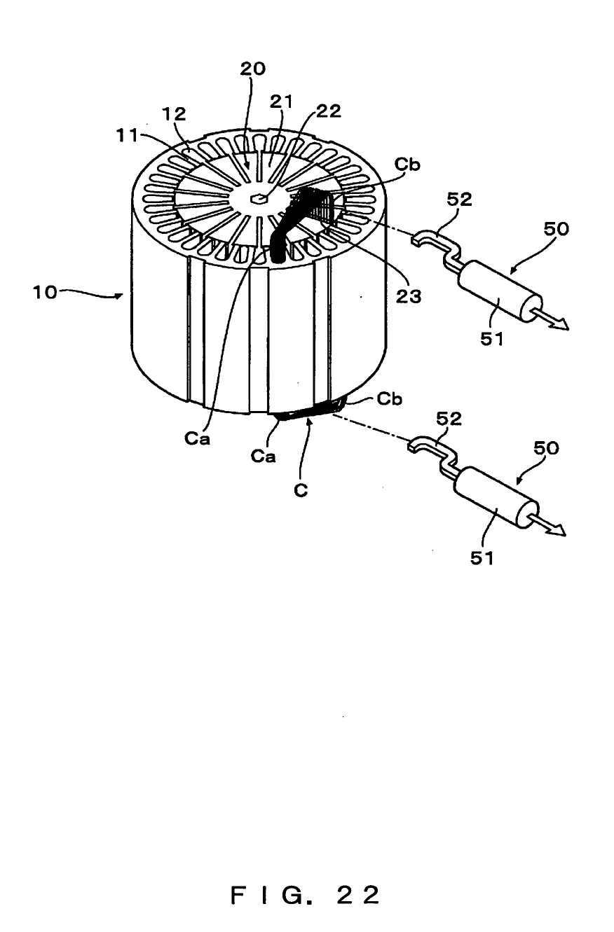

FIG. 22 shows a further mode for embodying the present invention with the push out device changed in the producing method according to the present invention.

In this mode, a drawing device 50 is used as a push out device for the coil C. The drawing device 50 is provided on both end surfaces of the stator core 10, and has an arm 51 provided as possibly traveling forward and backward near the both end surfaces along the radius, and a hook 52 attached at the tip of the arm 51. Then, the arm 51 is moved toward the inner circumference of the stator core 10, the hook 52 is hung on other side Cb of the coil C, and then the arm 51 is returned toward the outer circumference, thereby drawing the other side Cb of the coil C toward the outer circumference. By a pair of drawing devices 50 arranged near both end surfaces of the stator core 10 pulling the other side Cb of the coil C toward the outer circumference with the side hung on the hook 52, the other side Cb can be pushed into the corresponding slot 12 from the holding groove 23.

In FIG. 22, only pair of drawing devices 50 are shown, but actually, pair of drawing devices 50 are radially arranged at the outer circumference of the stator core 10 corresponding to each coil C.

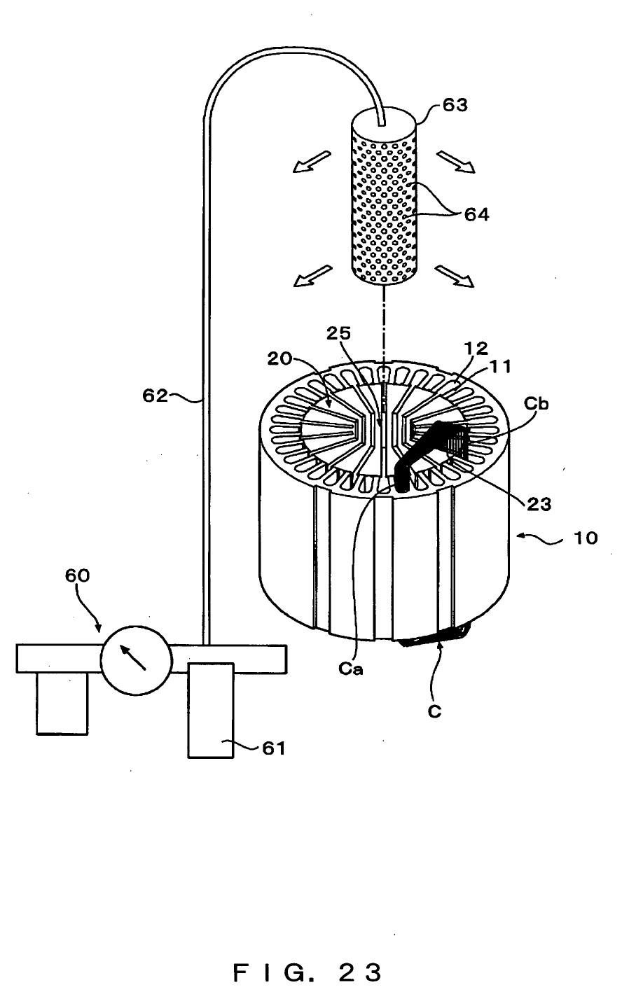

FIG. 23 shows another mode for embodying the present invention with the push out device changed in the producing method according to the present invention.

In this mode for embodying the present invention, an air pressure device 60 is used as a push out device. The air pressure device 60 has an air pressure machine 61 for supplying compressed air, a tube for supplying the air, and a nozzle 63 attached at the tip portion of the tube 62. The nozzle 63 is cylindrical, and a number of spouts 64 are formed on the circumference surface. The jig 20 is provided with a central hole 25. The nozzle 63 is inserted into the hole 25. In the holding groove 23 of the jig 20, a slit-shaped aperture led to the hole 25 is formed at the end portion in the side end portion of the inner circumference. Therefore, by arranging the nozzle 63 in the hole 25 of the jig 20 and supplying compressed air to the nozzle 63 through the tube 62 by the air pressure machine 61, the compressed air is blown from the spouts 64 of the nozzle 63, the compressed air is supplied from the aperture at the inner circumference of the holding groove 23 of the jig 20, and the other side Cb of the coil C held in the holding groove 23 is pushed into the predetermined slot 12. The air pressure device 60 can also be used with each of the above-mentioned push out devices.

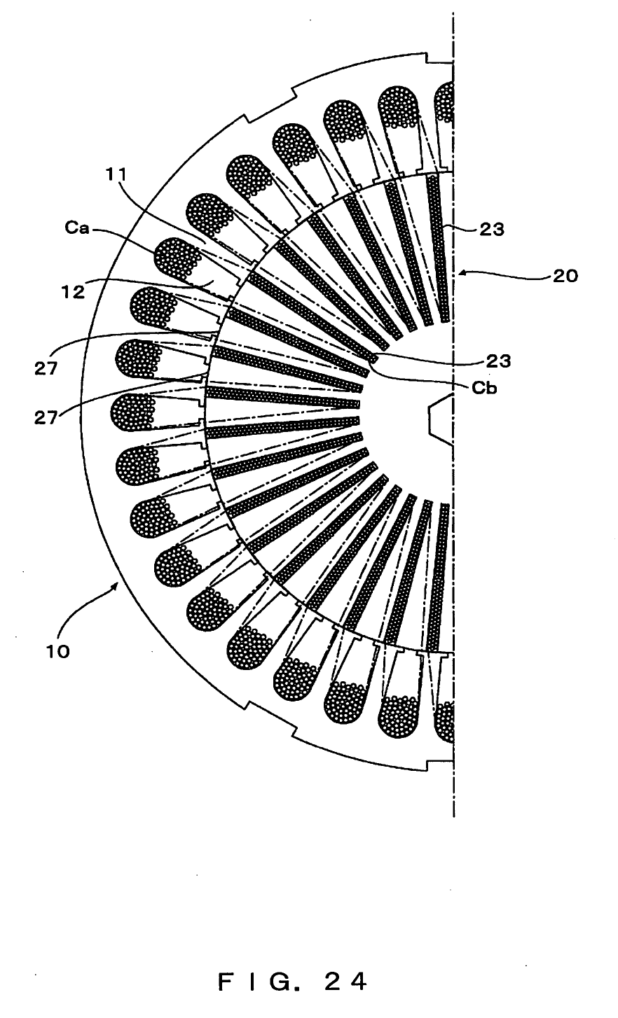

FIGS. 24 through 26 show a further mode for embodying the producing method according to the present invention.

In this mode for embodying the present inventions the number of the holding grooves 23 of the jig 20 is the same as the number of the slot 12 of the stator core 10. That is, the holding grooves 23 are provided with the pitch of the slot 12. The other Cb is inserted into the holding groove 23 of the jig 20 and held therein, and each coil C is arranged along the circumference of the jig 20 with one side Ca exposed outside, and the auxiliary member 70 is provided in this state, and one side Ca of the coil C is exposed outside through the space 73 of the blade portion 72 of the auxiliary member 70. Then, the jig 20 is rotated and positioned such that the blade portion 72 of the auxiliary member 70 can touch the inner circumference of each inner tooth 11 of the stator core 10, and the jig 20 is inserted into the inner circumference of the stator core 10 from the auxiliary member 70 side, thereby pressing one side Ca of the coil C projected outside the edge portion 27 of the jig 20, and inserting the one side Ca of the coil C into the corresponding slot 12 of the stator core 10 through the space 73 of the blade portion 72. FIG. 24 shows the state of inserting one side Ca of the coil C into each of the corresponding slots 12 of the stator core 10 as in the method shown in FIGS. 3 through 5. The other side Cb of the coil C is inserted into the holding groove 23 of the jig 20 adjacent to the slot 12, and held therein.

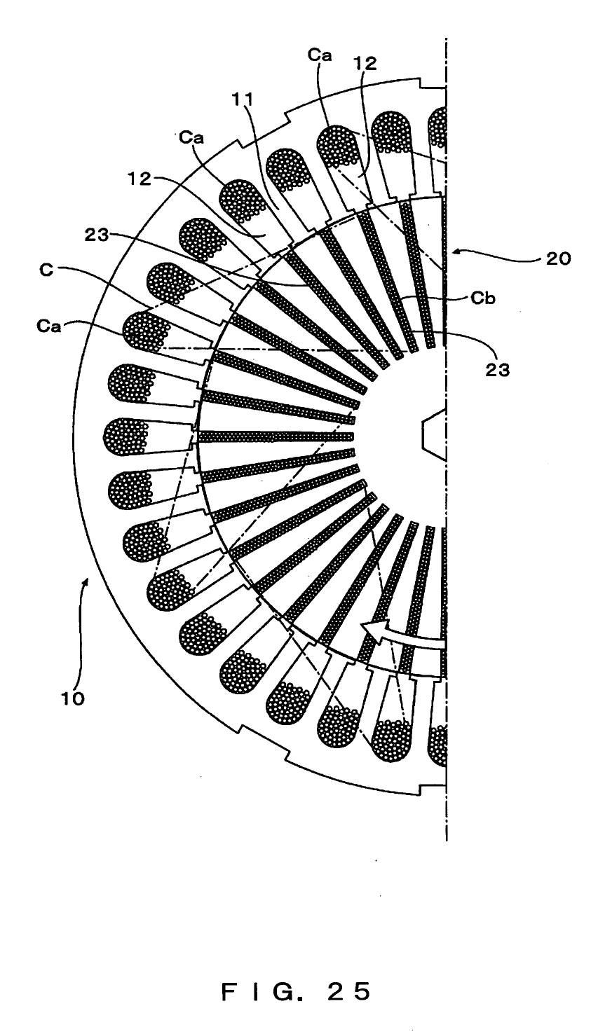

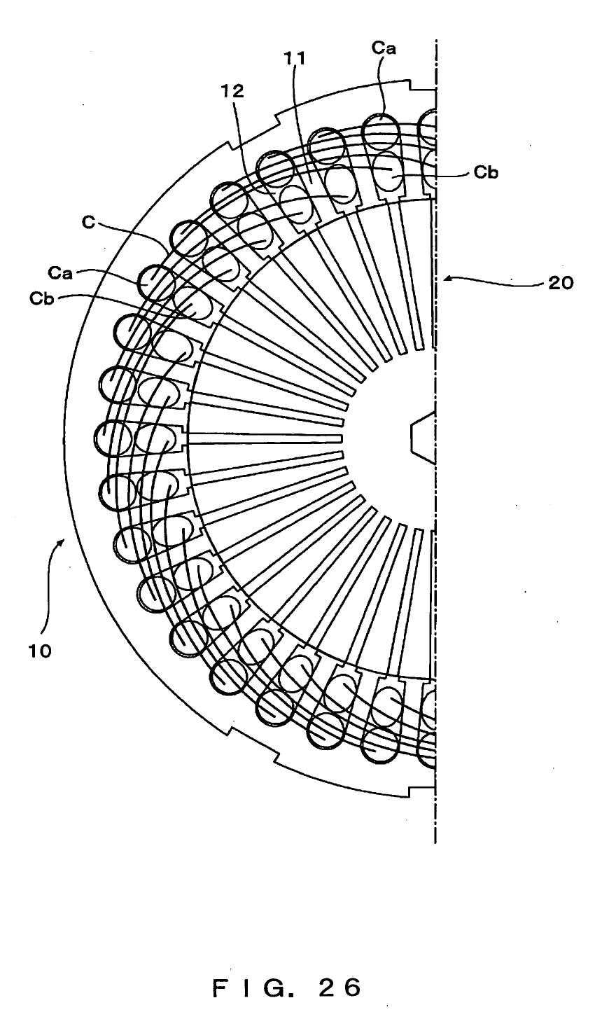

Next, as shown in FIG. 25, the jig 20 is rotated by predetermined degrees, and positioned such that the holding groove 23 holding the other side Cb of the coil C can match the fifth slot from the slot 12 into which one side Ca is inserted. In this state, using the push out device, for example, using the pressure jig 30 shown in FIG. 1, the other side Cb of the coil C held in the holding groove 23 is pushed out toward the outer circumference, and inserted into the corresponding slot 12. As a result, as shown in FIG. 26, the one side Ca of the coil C is inserted toward the outer circumference in each slot 12, and the other side Cb of the coil C is inserted toward the inner circumference of the slot 12, thereby entering the state in which two coils are inserted into one slot 12.

In the thus obtained stator core 10, the coil having one side Ca of the coil C positioned on the outer circumference side and the other side Cb positioned on the inner circumference side has coil ends spirally overlapping on the end surface of the stator core 10.

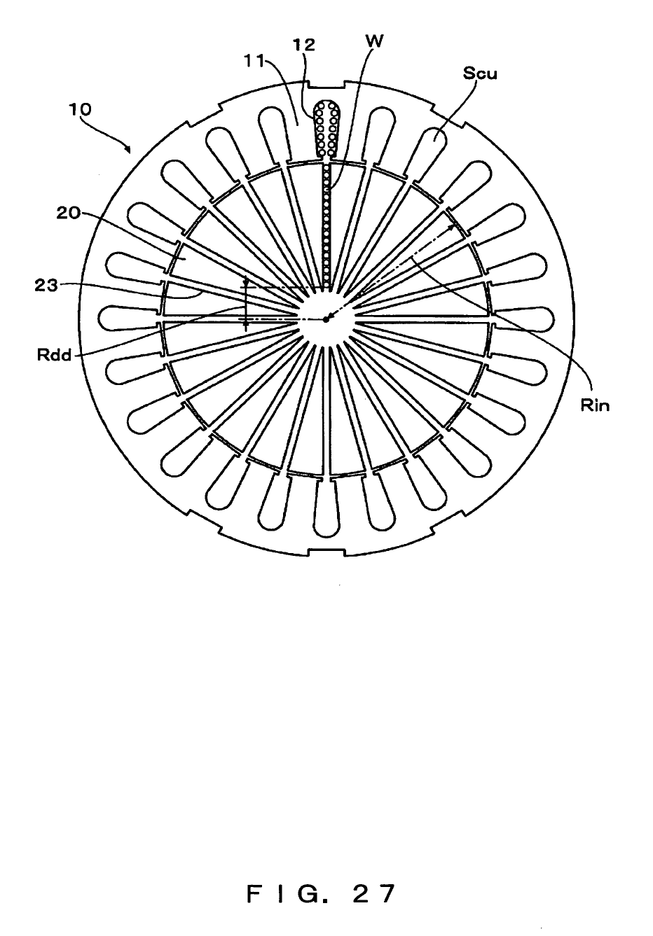

FIG. 27 is an explanatory view for considering the relationships among the total sectional area Scu of the coil C filled in the slot 12, the width d of the holding groove, the number of slots Slot, and the radius Rin in the stator using as a model the case in which the coil line of each coil C is inserted into each holding groove 23 and arranged in a line.

That is, when the line of the coil C is arranged in a line on the holding groove 23 of the jig 20, and inserted into the slot 12 of the stator core 10 from the holding groove 23, and by assuming that the total sectional area of the coils inserted into the slots 12 is Scu, the inner radius of the stator core 10 is Rin, the number of slots is Slot, and the width of the holding groove is d, the following equations 1 and 2 hold.

(when only one coil is inserted into each slot: for example, in the case of the mode for embodying the present invention shown in FIG. 9-15)
Scu>(Rin−Rdd)×d={Rin−(d×Slot/(4π))}×d=Rin×d−Slot×d²/4π [equation 1]
(in the case where two coils are inserted into each slot: for example, in the case of the mode for embodying the present invention shown in FIGS. 24-26)
Scu>(Rin−Rdd)×d×2={Rin−(d×Slot/(2π))}×d×2=2×Rin×d−Slot×d²/π [equation 2]

Therefore, for the stator core to which the above-mentioned equations can be applied, a line of coils C is arranged for the holding groove 23 of the jig 20, and can be inserted into the slot 12 of the stator core 10 from the holding groove 23, thereby appropriately realizing the producing method according to the present invention.

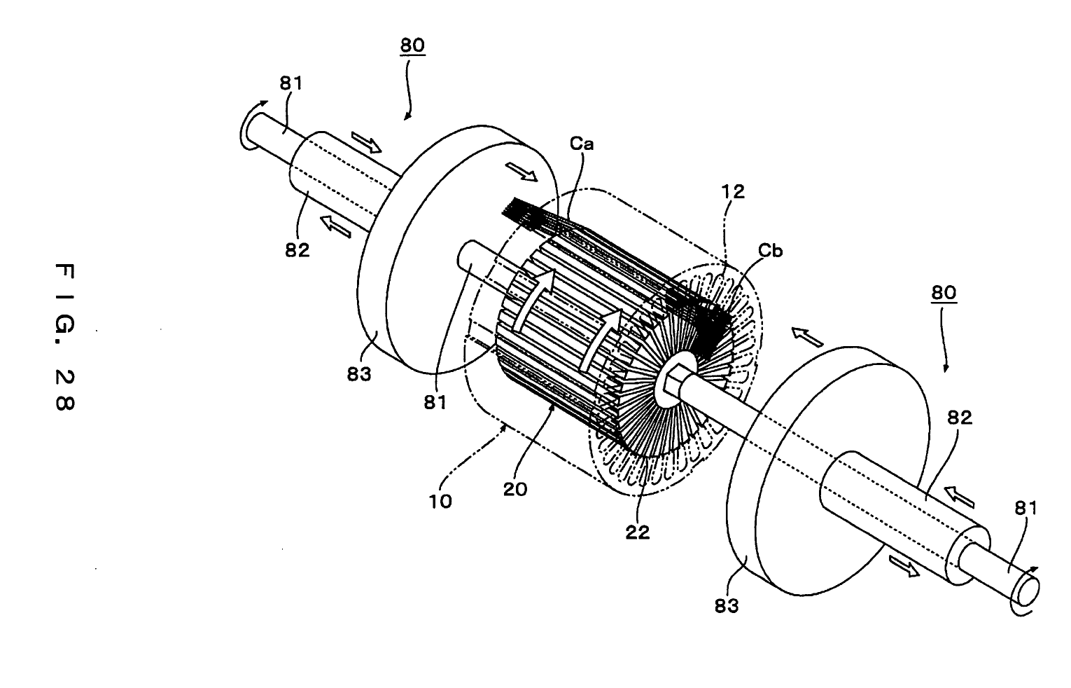

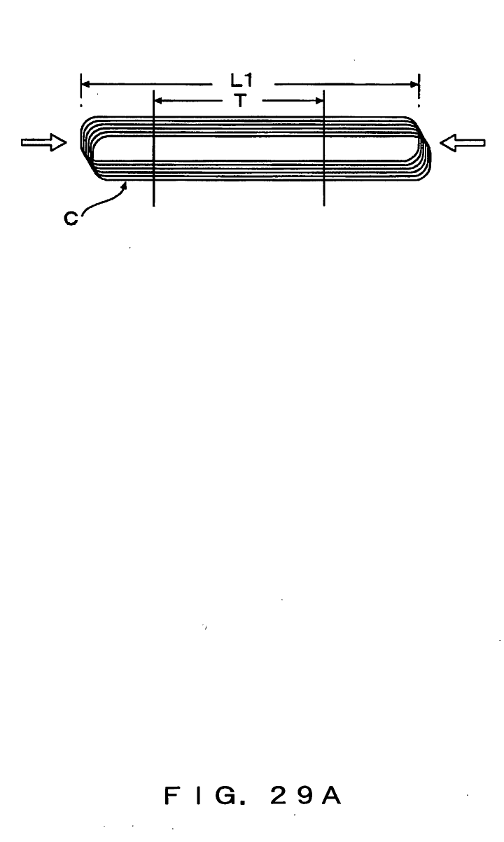

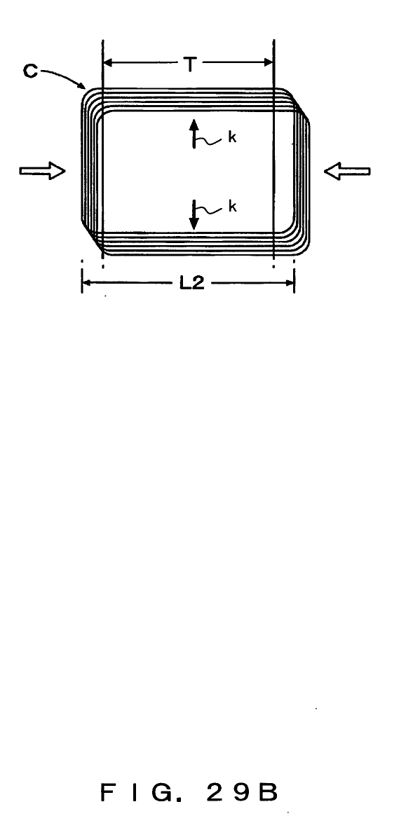

FIGS. 28 and 29 show another mode for embodying the producing method according to the present invention.

In the mode for embodying the present invention, when the one side Ca of the coil C is inserted into the slot 12 of the stator core 10, the jig 20 is rotated by predetermined degrees, and the holding groove 23 holding the other side Cb is positioned in a predetermined slot 12, the coil ends projecting from the both end surfaces of the stator core 10 and the jig 20 are pressed by a pair of rotation support jigs 80 in the axis direction toward the jig 20.

That is, as shown in FIG. 28, the rotation support jig 80 has a spindle 81 inserted into the hole 22 of both end surfaces of the jig 20, a cylindrical body 82 attached possibly slid on the spindle 81, and a flange-shaped pressure board 83 attached at the end portion of the cylindrical body 82 faces to the jig 20. By sliding the cylindrical body 82 and the pressure board 83 along the spindle 81 as indicated by the arrow shown in FIG. 30, the coil ends are pressed along the axis.

In FIG. 29, T indicates the thickness of the stator core 10 and the jig 20. FIG. 29A shows the state in which the coil ends of the coil C is not pressed, and the coil C forms a loop extending by the length of L1 in the axis direction of the stator core 10 and the jig 20, thereby long projecting the coil ends. On the other hand, FIG. 29B shows the state in which the pressure board 83 of the rotation support jig 80 presses the coil ends of the coil C, and the axial length L2 of the coil C in the axial direction of the stator core 10 and the jig 20 is short, and the coil is expanded in the width direction as indicated by the arrow k shown in FIG. 29B.

As a result, when the jig 20 is rotated against the stator core 10 and the loop of the coil C is expanded, the pressure board 83 of the rotation support jig 80 presses the coil ends, thereby expanding the coil C in the width direction, expanding the coil against the rigidity of the coil C, reducing the force exerted on the jig 20, and preventing the partition portions of the holding grooves 23 of the jig 20 from being deformed.

In each of the above-mentioned embodiments, the coil C can be held in the slot 12 using the electromagnetic suction. For example, by continuously passing an electric current through the coil C after inserting the one side Ca (C1a, C2a), the one side Ca (C1a, C2a) can be pressed to the stator core 10 as a magnetic substance. In the case of the push out device using the Lorentz force, the electric current is passed in the direction in which the other side Cb (C1b, C2b) does not projected from the holding groove 23 or the current through the electromagnet is stopped and remove the magnetic field G when the electromagnet Em is used. Thus, the one side Ca (C1a, C2a) can be more correctly held in the slot 12.

By similarly passing the current continuously through the coil C after inserting the other side Cb (C1b, C2b), the one side Ca (C1a, C2a) and the other side Cb (C1b, C2b) can be correctly held in the slot 12.

By continuously passing the current through the coil C when the jig 20 is rotated and positioned after inserting the one side Ca (C1a, C2a), the electromagnetic suction prevents the one side Ca (C1a, C2a) from projecting from the slot 12 by the force generated by the rotation of the jig 20, and from being pressed between the stator care 10 and jig 20. In the case of the push out device using the Lorentz force, the electric current is passed in the direction in which it does not project from the holding groove 23, thereby correctly holding the other side Cb (C1b, C2b) on the holding groove 23, preventing the other side Cb (C1b, C2b) from projecting from the holding groove 23 by the force of the rotation of the jig 20, and then preventing it from being pressed between the stator core 10 and the jig 20.

The current passed to generate the electromagnetic suction can be a current whose repulsion by the eddy-current in the coil C can be ignored. For example, it can be a direct current or an alternating current of 20 Hz or less.

In the above-mentioned mode for embodying the present invention, the other side Cb (C1b, C2b) is inserted from the slot into which the one side Ca (C1a, C2a) is inserted into the fifth slot 12 ahead, but the position of the slot is not limited to the fifth.

In FIGS. 16 through 18, the inserting step is performed twice or more when only one coil is inserted into each slot, but the inserting step can be performed twice or more when two coils are inserted into each slot shown in FIGS. 24 through 28.

What is claimed is:

1. A method for producing a stator formed by inserting one side of each of a plurality of prepared coils into each slot, and then inserting the other side of each of the plurality of prepared coils into another slot, comprising:
using a jig having on an outer circumference a holding groove group formed by a plurality of slit-shaped holding grooves with pitches of integral multiple pitches of the slot of the stator core;
projecting one side of each of the plurality of prepared coils outside the jig, and arranging each coil along the circumference of the jig with the other side inserted into the holding groove group;
mounting on the end surface of the jig an auxiliary member having a plurality of blade portions provided corresponding to one or more inner teeth of the stator core, and holding one side of each of the plurality of prepared coils in the corresponding space between the blade portions;
inserting the jig into the inner circumference of the stator core from the auxiliary member side, guiding one side of each of the plurality of prepared coils by the auxiliary member, and pushing one side of each of the plurality of prepared coils into a corresponding slot of the stator core by the edge portion of the jig; and
thus rotating the jig arranged at the inner circumference of the stator core, arranging the jig such that the holding groove can match a corresponding slot of the stator core, pushing the other side of each of the plurality of prepared coils toward the outer circumference by a push out device, and inserting the other side of each of the plurality of prepared coils into a corresponding slot of the stator core.

2. The method according to claim 1, wherein
overlapped coils are inserted by repeating two or more times the operation of inserting one side of each of the plurality of prepared coils and the other side of each of the plurality of prepared coils into the slots by the jig.

3. The method according to claim 1, wherein
a push out jig obtained by arranging a tabular pusher which narrows toward a tip on the holding groove is used as the push out device, the tip of the pusher of the push out jig is inserted into each of the corresponding holding grooves, the other side of each of the plurality of prepared coils inserted into the holding groove is pushed out toward the outer circumference, and inserted into the corresponding slot of the stator core.

4. The method according to claim 2, wherein
a push out jig obtained by arranging a tabular pusher which narrows toward a tip on the holding groove is used as the push out device, the tip of the pusher of the push out jig is inserted into each of the corresponding holding grooves, the other side of each of the plurality of prepared coils inserted into the holding groove is pushed out toward the outer circumference, and inserted into the corresponding slot of the stator core.

5. The method according to claim 1, wherein
a device for generating repulsion by an eddy-current by passing an electric current through a coil is used as the push out device, and the other side of each of the plurality of prepared coils is pushed out by the repulsion toward the outer circumference from the holding groove of the jig, and inserting the other side of each of the plurality of prepared coils into the corresponding slot of the stator core.

6. The method according to claim 2, wherein
a device for generating repulsion by an eddy-current by passing an electric current through a coil is used as the push out device, and the other side of each of the plurality of prepared coils is pushed out by the repulsion toward the outer circumference from the holding groove of the jig, and inserting the other side of each of the plurality of prepared coils into the corresponding slot of the stator core.

7. The method according to claim 1, wherein
a device for generating a Lorentz force by passing a current through a coil by generating a magnetic field traversing the holding groove of the jig is used as the push out device, and the other side of each of the plurality of prepared coils is pushed out by the Lorentz force toward the outer circumference from the holding groove of the jig, and inserted into the corresponding slot of the stator core.

8. The method according to claim 2, wherein
a device for generating a Lorentz force by passing a current through the coil by generating a magnetic field traversing the holding groove of the jig is used as the push out device, and the other side of each of the plurality of prepared coils is pushed out by the Lorentz force toward the outer circumference from the holding groove of the jig, and inserted into the corresponding slot of the stator core.

9. The method according to claim 1, wherein
a direct current or an alternating current of a low frequency of 20 Hz or lower is passed through the coil inserted into the slot of the stator core, and the coil is pressed toward the stator core.

10. The method according to claim 1, wherein
the jig is rotated while pushing one side of each of the plurality of prepared coils toward the stator core and the other side of each of the plurality of prepared coils toward the jig with a direct current or an alternating current at a low frequency of 20 Hz or lower passing through the coil when the jig is rotated with the slot of the stator core with one side of each of the plurality of prepared coils inserted into the corresponding slot of the stator core, and the other side of each of the plurality of prepared coils inserted and held in the holding groove of the jig.

11. The method according to claim 1, wherein
using a pair of rotation auxiliary jigs each coil end projecting from the both end surfaces of the stator core and the jig is pressed toward the jig in the axis direction when the jig is rotated with the slot of the stator core with one side of each of the plurality of prepared coils inserted into the corresponding slot of the stator core, and the other side of each of the plurality of prepared coils inserted and held in the holding groove of the jig.

12. The method according to claim 1, wherein
the side of each coil is inserted one by one into each slot in one operation by inserting one side of each of the plurality of prepared coils into every second slot of the stator core and then inserting the other side of each of the plurality of prepared coils into the remaining slot.

13. The method according to claim 12, wherein
when a total sectional area of the coil inserted into the slots of the stator core is Scu, an inner radius of the stator core is Rin, a number of slot is Slot, and a width of the holding groove is d, the method is applied to a stator core satisfying an equation of Scu>Rin·d−Slot·d²/4π.

14. An apparatus for producing a stator by inserting one side of each of a plurality of prepared coils into each slot, and then inserting other side of each of the plurality of prepared coils into another slot, comprising:
a jig capable of being inserted inside an inner circumference of a stator core, and having on an outer circumference a holding groove group formed by a plurality of slit-shaped holding grooves with pitches of integral multiple pitches of the slot of the stator core;
an auxiliary member having a plurality of blade portions provided corresponding to one or more inner teeth of the stator core; and
a push out device for inserting the coil inserted into the holding groove group of the jig into a corresponding slot.
